(19) United States
(12) Patent Application Publication
(10) Pub. No.: US 2012/0075556 A1
(43) Pub. Date: Mar. 29, 2012

(54) LOCALLY CONTROLLABLE BACKLIGHT

(75) Inventors: Haikuo GAO, Beijing (CN); Daekeun YOON, Beijing (CN); Xiaopan ZHENG, Beijing (CN); Ji CHEN, Beijing (CN); Hetao WANG, Beijing (CN)

(73) Assignee: BEIJING BOE OPTOELECTRONICS TECHNOLOGY CO., LTD, Beijing (CN)

(21) Appl. No.: 13/241,992

(22) Filed: Sep. 23, 2011

(30) Foreign Application Priority Data
Sep. 26, 2010 (CN) 201020543389.1

(51) Int. Cl. G02F 1/13357; F21V 13/02; F21V 13/12; F21V 8/00

(52) U.S. Cl. 349/65; 362/610

(57) ABSTRACT

A backlight is provided and comprises an optical fiber light-emitting panel comprising an optical fiber light-emitting panel comprising at least one optical fiber light-emitting unit, wherein each optical fiber light-emitting unit comprises a light-emitting portion and a light-guiding portion which are connected together, the light-emitting portion forms a plane emitting area and the light-guiding portion extends to a side edge of the optical fiber light-emitting panel; and at least one illuminating light which is provided at the end surface of the light-guiding portion. Further, a liquid crystal display is provided.

### BACKGROUND

Embodiments of the disclosed technology relate to a backlight and a liquid crystal display.

A backlight is the component for providing illuminating light in a liquid crystal panel. A locally controllable backlight is a kind of backlights, the light emitting areas of which can be independently controlled to light on or off as required. The existing locally controllable backlight mainly can be of a side-light type or a straight-down type.

The technique about a side-light type backlight uses a light-guiding plate structure, which guides light emitted by light-emitting diodes (LEDs) to enter from one side to each emitting area, to form a local plane light source to emit light. Because of a relatively large volume and being difficult to assemble, this light-guiding plate is not suitable for a small-sized backlight module assembly for a notebook computer and so on.

In a straight-down type locally controllable backlight, for each emitting area, a plane light source including LEDs is provided to illuminate directly upward. Since it is necessary to maintain a distance for mixing light, the volume of the backlight is relatively bulky, which is also somewhat unsuitable for a small-sized backlight module assembly for a notebook computer and so on.

Additionally, the above two types of locally controllable backlights further have common technical problems as follows. Each emitting area is located in a different position on the liquid panel, and LEDs are configured in each emitting area; in order to realize the local control, it is necessary to provide a drive circuit for each emitting area to turn the corresponding LEDs on or off. Since the emitting areas are independent from each other, the correspondingly drive circuits are generally provided separately in reply to the positions of the emitting areas. Therefore, it is difficult to arrange these drive circuits collectively, which results in the difficulty of circuit design.

### SUMMARY

One aspect of the disclosed technology provides an locally controllable backlight comprising: an optical fiber light-emitting panel comprising an optical fiber light-emitting panel comprising at least one optical fiber light-emitting unit, wherein each optical fiber light-emitting unit comprises a light-emitting portion and a light-guiding portion which are connected together, the light-emitting portion forms a plane emitting area and the light-guiding portion extends to a side edge of the optical fiber light-emitting panel; and at least one illuminating light which is provided at the end surface of the light-guiding portion .

Another aspect of the disclosed technology provides an liquid crystal display comprising: a crystal panel; and a backlight including an optical fiber light-emitting panel comprising at least one optical fiber light-emitting unit, wherein each optical fiber light-emitting unit comprises a light-emitting portion and a light-guiding portion which are connected together, the light-emitting portion forms a plane emitting area and the light-guiding portion extends to a side edge of the optical fiber light-emitting panel; and at least one illuminating light which is provided at the end surface of the light-guiding portion.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWINGS

The disclosed technology will become more fully understood from the detailed description given hereinafter and the accompanying drawings which are given by way of illustration only, and thus are not limitative of the disclosed technology and wherein:

FIG. 1 is a structure schematic view of a first embodiment of the locally controllable area backlight of the disclosed technology;

FIG. 2 is an operating principle schematic view of the light-guiding portion in FIG. 1;

FIG. 3 is an operating principle schematic view of the light-emitting portion in FIG. 1;

FIG. 4 is a structure schematic view of a second embodiment of the locally controllable area backlight of the disclosed technology; and

FIG. 5 is a structure schematic view of a third embodiment of the locally controllable area backlight of the disclosed technology.

### DETAILED DESCRIPTION

In order to make the purpose, technical solutions and advantages of the disclosed technology more clearly, the technical solutions in the embodiments of the disclosed technology combined with the drawings in the embodiments of the disclosed technology will be described clearly and integrally below, and it is obviously that the described embodiments are a part of the embodiments of the disclosed technology, but not all of them. Based on the embodiments in the disclosed technology, all the other embodiments achieved by those skilled in the art on the precondition of no creative work being done belong to the protection scope of the disclosed technology.

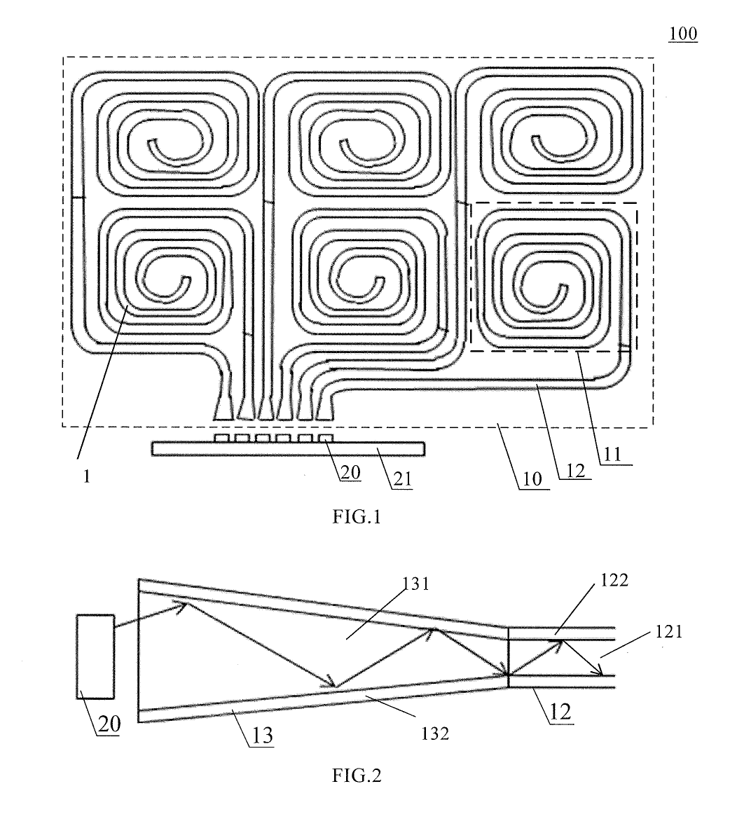

FIG. 1 is a structure schematic view of a first embodiment of the locally controllable area backlight of the disclosed technology. As shown in FIG. 1, the locally controllable backlight 100 at least comprises an optical fiber light-emitting panel 10 comprising at least one optical fiber light-emitting unit 1 and at least one illuminating light 20. Each optical fiber light-emitting unit 1 comprises a light-emitting portion 11 and a light-guiding portion 12 which are connected together; the light-emitting portion 11 forms a plane emitting area, and the light-guiding portion 12 extends to a side edge of the optical fiber light-emitting panel 10. At the end surfaces of light-guiding portions 12 for light-emitting units 1, at least one illuminating light 20 is provided correspondingly. The backlight 100 may also comprise a fixing structure such as a frame to fix the at least one light-emitting unit 1, and also light-emitting units may be fixed to each other by transparent bonding agent and the like, to obtain a light-emitting panel in a plate shape.

The at least one illuminating light 20 may be provided on a light strip 21, which is, for example, in a strip-like shape and is provided on a side edge of the optical fiber emitting panel 10. With providing an illuminating light 20 on a light strip 21, it is convenient to mount and control the illuminating light 20.

The operating principle of the locally controllable backlight of the disclosed technology will be described in detail in the following.

As shown in FIG. 2, the illuminating light 20 is provided at the end surface of a light-guiding portion 12. This illuminating light 20 can be a LED or a fluorescent lamp for irradiating light into the light-guiding portion 12. In order to lead the light emitted from the illuminating light 20 into the light-guiding portion 12, a light cone 13 may also be provided on the end surface of the light-guiding portion 12. As shown in FIG. 2, the optical cone 13 includes an outer wall 132 and a core 131 surrounded by the outer wall 132. Due to the refractive index of the material of the outer wall 132 of the optical cone 13 is smaller than that of the material of the inner core 131, the light emitted from the illuminating light 20 is transmitted into the light-guiding portion 12 based on the total reflection principle after entering the light cone 13, to realize the optical coupling. The light-guiding portion 12 can be embodied as a light-guiding optical fiber, which comprises an outer wall 121 and a core 122 surrounded by the outer wall 121. The refractive index of material of the outer wall 121 is also smaller than that of the material of the inner core 122, such that the light entering the light-guiding portion can be transmitted to the light-emitting portion 11 also based on the total reflection principle.

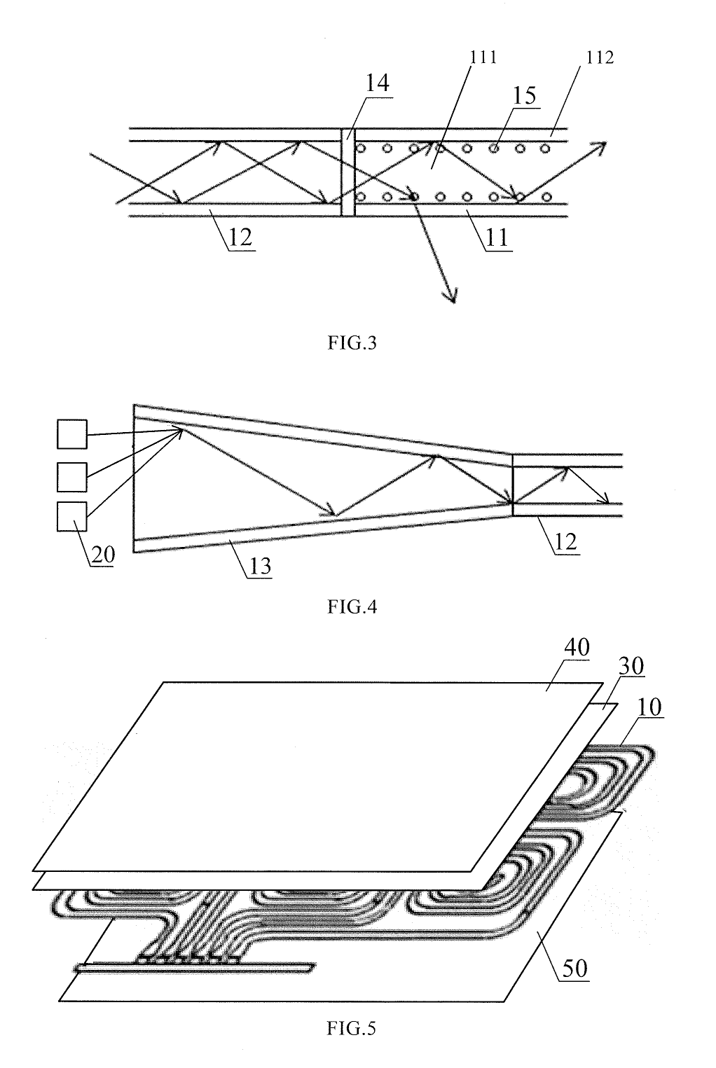

As shown in FIG. 3, the light-emitting portion 11 and the light-guiding portion 12 are connected together, e.g., by bonding their end surfaces together with a transparent adhesive tape or the like. As described above, the light-guiding portion 12 transmits the light which is from the illuminating light 20 to the light-emitting portion 11, and after that, the light is transmitted within the light-emitting portion 11. For example, the light-emitting portion 11 may be a side-emitting optical fiber (or whole body emitting optical fiber) to prevent the abnormal bright spot from occurring in the emitting area. The light-emitting portion 11 may also comprise for example an outer wall 111 and a core 112 surrounded by the outer wall 111.

As described above, the refractive index of the material of the outer wall of an optical fiber is usually smaller than that of the inner material in order to create the condition for total reflection. In this embodiment, in order to emit the light from the light-emitting portion 11 to realize the function of emitting light, diffusion particles 15 may further provided in the inner material of the side-emitting optical fiber. The refractive index of these diffusion particles 15 is different from that of the inner material of the side-emitting optical fiber, and the diffusion particles for example may be glass spheres, bubbles and so on. When the light transmitted inside the light-emitting portion 11 irradiates on the diffusion particles 15, the original total reflection condition of the side-emitting optical fiber is broken, which makes the light capable of being emitted from the side of the light-emitting portion 11 to the outside of the light-emitting portion 11 so as to realize illumination. Additionally, other appropriate ways may also be utilized to realize the side emitting optical fiber.

The optical fibers utilized in this embodiment may be a glass optical fiber, a plastic optical fiber and etc. According to the distribution of the core-outer refraction index difference in the wall, optical fibers can be classified into graded-index polymer optical fibers (GI-POF) and step-index polymer optical fibers (SI-POF).

As shown in FIG. 1, the light-emitting portion 11 could be coiled spirally so as to form the light-emitting unit 1 of the plane emitting area. The at least one optical fiber emitting unit 1 has the similar structure mentioned above. By controlling the illuminating light 20 on and off corresponding to each optical fiber emitting unit 1 and in turn to control the light-emitting portion 11 on and off, a locally controllable backlight can be provided.

Furthermore, more than one light strips 21 may be provided for the light-guiding portion of each light-emitting unit. These light strips may be provided on the same side or on the different sides of the panel, for example, on the two sides which are opposite to each other.

The locally controllable backlight described in this embodiment utilizes the optical fiber light-emitting panel to emit light and thus can have a small volume and be in a light and thin structure, t suitable for a small-sized backlight module assembly for a notebook computer and the like.

In addition, the light-guiding portion is provided to extend to a side edge of the optical fiber light-emitting panel in the locally controllable backlight described in this embodiment, and the illuminating lights are provided on this edge; therefore, the drive circuits for controlling these illuminating lights can be provided near the side edge so as to helpful to simplify the circuit design.

In the above embodiment, each light-emitting unit 1 includes one optical fiber coiled spirally. However, each light-emitting unit 1 may include two optical fibers; for example, in the case where each light-emitting unit 1 include two optical fibers, the two optical fibers may be coiled in an alternative manner or be combined with the head of one fiber opposite to the tail of another fiber, so as to enhance the brightness uniformity of each light-emitting unit 1.

FIG. 4 is the structure schematic view of a second embodiment of the locally controllable area backlight of the disclosed technology. This embodiment makes further a modification on the basis of the above embodiment. As shown in this drawing, in this embodiment, at the end surface of the light-guiding portion 12 of each optical fiber light-emitting unit 1, more than one illuminating light 20 is provided.

In the locally controllable backlight described in this embodiment, with providing more than one illuminating light for each optical fiber light-emitting unit, when making area control, a part of the illuminating lights can be controlled independently so as to change the brightness of the light-emitting portion of one optical fiber light-emitting unit; thus, the locally controllable backlight can be controlled in a finer way, helpful to further reduce the power consumption.

FIG. 5 is the structure schematic view of a third embodiment of the locally controllable area backlight of the disclosed technology. This embodiment makes further a modification on the basis of the above embodiment. As shown in this drawing, a reflecting sheet 50 may further be provided under the optical fiber light-emitting panel 10 for reflecting the light emitted downward from optical fiber light-emitting panel 10 to the top surface so as to improve the utilization rate of the light.

In addition, a diffusing sheet 30 may further be provided on the top surface of the optical fiber light-emitting panel 10 for diffusing the light emitted from the optical fiber light-emitting panel 10, such that the light emitted by the diffusing sheet 30 can be more uniform, improving display quality. Additionally, the top surface of the diffusing sheet 30 may further be provided with a prism sheet 40 for converging the light emitted from the diffusing sheet 30 into the range of view angle so as to increase the brightness in the visible range of the optical fiber light-emitting unit.

Another embodiment of the disclosed technology provides a liquid crystal display comprising a liquid panel and a backlight. The backlight comprises one of the embodiments of the locally controllable backlight of the disclosed technology. Such liquid crystal display can be used for a device such as a notebook computer and the like.

The embodiment of the disclosed technology being thus described, it will be obvious that the same may be varied in many ways. Such variations are not to be regarded as a departure from the spirit and scope of the disclosed technology, and all such modifications as would be obvious to those skilled in the art are intended to be included within the scope of the following claims.

What is claimed is:

1. A backlight, comprising:
an optical fiber light-emitting panel comprising at least one optical fiber light-emitting unit, wherein each optical fiber light-emitting unit comprises a light-emitting portion and a light-guiding portion which are connected together, the light-emitting portion forms a plane emitting area and the light-guiding portion extends to a side edge of the optical fiber light-emitting panel; and
at least one illuminating light which is provided at the end surface of the light-guiding portion.

2. The backlight according to claim 1, wherein the at least one illuminating light is provided on a light strip, and the light strip is provided on the side edge of the optical fiber light-emitting panel.

3. The backlight according to claim 1, wherein the light-emitting portion comprises at least one fiber which is coiled spirally.

4. The backlight according to claim 3, wherein the light-emitting portion comprises two optical fibers which are coiled alternatively to each other.

5. The backlight according to claim 1, wherein the light-emitting portion is a side-emitting optical fiber.

6. The backlight according to claim 5, wherein diffusion particles are provided in the inner material of the side-emitting optical fiber.

7. The backlight according to claim 1, wherein a light cone is provided on the end surface of the light-guiding portion for leading the light emitted from the illuminating light into the light-guiding portion.

8. The backlight according to claim 1, wherein at the end surface of the light-guiding portion of each optical fiber light-emitting unit, more than one illuminating light is provided.

9. The backlight according to claim 1, further comprising a reflecting sheet provided under the optical fiber light-emitting panel.

10. The backlight according to claim 1, further comprising a diffusing sheet provided on the top surface of the optical fiber light-emitting panel.

11. The backlight according to claim 10, further comprising a prism sheet provided on the top surface of the diffusing sheet.

12. The backlight according to claim 1, wherein the illuminating light is a light-emitting diode or a fluorescent lamp.

13. A liquid crystal display comprising:
a liquid crystal panel; and
a backlight comprising:
an optical fiber light-emitting panel comprising at least one optical fiber light-emitting unit, wherein each optical fiber light-emitting unit comprises a light-emitting portion and a light-guiding portion which are connected together, the light-emitting portion forms a plane emitting area and the light-guiding portion extends to a side edge of the optical fiber light-emitting panel; and
at least one illuminating light which is provided at the end surface of the light-guiding portion.
